(19) United States
(12) Patent Application Publication
(10) Pub. No.: US 2019/0314727 A1
(43) Pub. Date: Oct. 17, 2019

(54) METHODS AND SYSTEMS FOR JOINING BATTLE IN PROCESS

(71) Applicant: LINE Up Corporation, Seongnam-si (KR)

(72) Inventors: Yong Hyun LEE, Seongnam-si (KR); Jung Min PARK, Seongnam-si (KR)

(73) Assignee: LINE Up Corporation, Seongnam-si (KR)

(21) Appl. No.: 16/379,204

(22) Filed: Apr. 9, 2019

(30) Foreign Application Priority Data
Apr. 16, 2018 (KR) 10-2018-0043709

(51) Int. Cl. A63F 13/795; A63F 13/35; H04L 29/06; G06F 3/0482

(52) U.S. Cl. CPC A63F 13/795; A63F 13/35; G06F 3/0482; H04L 67/38; H04L 65/1069

(57) ABSTRACT

A method includes establishing a communication session between a first second terminal, the communication session involving a game battle between a first user of the first terminal and a second user of the second terminal, providing a first entry request function to a third terminal to enable a third user of the third terminal to observe the game battle while the game battle is in progress, providing information for a battle screen corresponding to the game battle in progress in response to a request received through the provided first entry request function, providing a first join request function to the third terminal through the battle screen to enable the third user to join the game battle in progress, and processing the game battle among the first user, the second user, and the third user, in response to a request received through the provided first join request function.

### CROSS-REFERENCE TO RELATED APPLICATION(S)

This U.S. non-provisional application claims the benefit of priority under 35 U.S.C. § 119 to Korean Patent Application No. 10-2018-0043709 filed on Apr. 16, 2018 in the Korean Intellectual Property Office (KIPO), the entire contents of which are incorporated herein by reference.

### BACKGROUND

### Field

One or more example embodiments relate to methods, apparatuses, systems, and/or non-transitory computer-readable media for joining a battle in progress, and more particularly, to a battle join method that enables a user to enter a battle currently in progress between other users, to observe a progress of the battle, and to join the battle directly if desired, a computer apparatus for performing the battle join method, a computer program stored in a non-transitory computer-readable storage medium to perform the battle join method on the computer apparatus, and the non-transitory computer-readable storage medium storing instructions that, when executed by a processor, cause the processor to perform the battle join method.

### Description of the Related Art

A strategy game refers to a genre of a game in which the operational ability and strategic decision making of game users is featured. For example, a real-time game system for matching of siege strategy using a network may provide a strategy game to game users.

Various battle games including strategy battle games provide a game service for a battle between users. Also, the battle games may provide a function for other users to observe a corresponding battle. However, conventional strategy battle games merely permit users joining a battle at the start of the battle to authorize an observer such that the users having the authorization may observe the battle.

### SUMMARY

One or more example embodiments provide a battle join method that enables a user to enter a battle currently in progress between other users, to observe a progress of the battle, and to join the battle directly if desired, a computer apparatus for performing the battle join method, a computer program stored in a non-transitory computer-readable storage medium to perform the battle join method on the computer apparatus, and/or the non-transitory computer-readable storage medium storing computer-readable instructions that, when executed by at least one processor, cause the at least one processor to perform the battle join method.

According to an aspect of at least one example embodiment, there is provided a method performed by a server, the method may include establishing a communication session between a first terminal and a second terminal, the communication session involving a game battle between a first user of the first terminal and a second user of the second terminal; providing a first entry request function to a third terminal, the first entry request function being configured to enable a third user of the third terminal to observe the game battle while the game battle is in progress; providing information for a battle screen corresponding to the game battle in progress in response to a request received through the provided first entry request function; providing a first join request function to the third terminal through the battle screen, the first join request function being configured to enable the third user to join the game battle in progress; and processing the game battle among the first user, the second user, and the third user, in response to a request received through the provided first join request function.

The processing of the game battle may include allowing the third user to join the game battle on a first side corresponding to one of the first user or the second user.

The processing the game battle may include allowing a fourth user to join the game battle on a second side different from the first side in response to receiving a request through a second entry request function and a request through a second join request function.

The providing of the first entry request function may include providing a notification including the first entry request function for the game battle in progress to one or more other users having a personal relationship with at least one of the first user or the second user based on personal relationship data managed for the one or more other users.

The third user may have a personal relationship with at least one of the first user or the second user.

The providing of the first entry request function may include determining a grade of the third user, determining one or more game battles in progress between one or more other users within a defined threshold amount of the grade of the third user, and generating a link to be included in the first entry request function, the link corresponding to a selected single battle the third user is allowed to join.

The providing of the battle screen may include subtracting a fee corresponding to entry of the third user into the selected single battle from resources allocated to the third user at a game service.

According to an aspect of at least one example embodiment, there is provided a method performed by a terminal, the method may include causing display of a graphical user interface associated with a game service provided by a game server, the graphical user interface providing an entry request function configured to enable a user of the terminal to observe a game battle among two or more other users while the game battle is in progress through the game service; providing a request to the game server to observe the game battle in progress in response to a selection from the user associated with the entry request function; causing display of the graphical user interface including a battle screen for the game battle, the graphical user interface providing a join request function configured to enable the user to join the game battle in progress; providing a request to the game server to join the game battle in progress in response to a selection from the user associated with the join request function; and processing the game battle between the user and the two or more other users through communication with the game server.

According to an aspect of at least one example embodiment, there is provided a non-transitory computer-readable storage medium storing instructions that, when executed by at least one processor, cause the at least one processor to perform the method.

According to an aspect of at least one example embodiment, there is provided a computer apparatus including at least one processor configured to execute computer-readable instructions, wherein the at least one processor is configured to establish a communication session between a first terminal and a second terminal, the communication session involving a game battle between a first user of the first terminal and a second user of the second terminal, provide an entry request function to a third terminal, the entry request function being configured to enable a third user of the third terminal to observe the game battle while the game battle is in progress, provide information for a battle screen corresponding to the game battle in progress in response to a request received through the provided entry request function, provide a join request function to the third terminal through the battle screen, the join request function being configured to enable the third user to join the game battle in progress, and process the game battle among the first user, the second user, and the third user, in response to a request received through the provided join request function.

According to an aspect of at least one example embodiment, there is provided a computer apparatus including at least one processor configured to execute computer-readable instructions, wherein the at least one processor is configured to receive a game service through communication with a game server over a network, provide a user with an entry request function for requesting an entry into a battle currently in progress through the game service, request the game server for entry into a battle between other users currently in progress in response to a selection from the user on the entry request function, provide a battle screen for the battle between the other users; providing a join request function for the battle between the other users through the battle screen, request the game server to join the battle between the other users in response to a selection from the user on the provided join request function, and process the battle between the user and the other users through communication with the game server.

According to some example embodiments, it is possible to provide a new fun and strategy for a battle game by providing a game service such that a user may enter a battle currently in progress between other users, may observe a progress of the battle, and may directly join the battle if desired.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

Some example embodiments will be described in more detail with regard to the figures, wherein like reference numerals refer to like parts throughout the various figures unless otherwise specified, and wherein:

FIG. 1 illustrates an example of a network environment according to at least one example embodiment;

FIG. 2 illustrates an example of a computer apparatus according to at least one example embodiment;

FIG. 3 is a flowchart illustrating an example of a battle join method of a server according to at least one example embodiment;

FIG. 4 is a flowchart illustrating an example of a battle join method of a client according to at least one example embodiment;

FIG. 5 illustrates a first example of a game implementation that provides a notification about a battle according to at least one example embodiment;

FIG. 6 illustrates a second example of a game implementation that provides a notification about a battle according to at least one example embodiment;

FIG. 7 illustrates a third example of a game implementation that provides a notification about a battle according to at least one example embodiment;

FIG. 8 illustrates a fourth example of a game implementation that provides a notification about a battle according to at least one example embodiment;

FIG. 9 illustrates an example of a battle observation screen according to at least one example embodiment; and

FIG. 10 illustrates an example of a game implementation that provides a notification about a request for help according to at least one example embodiment.

It should be noted that these figures are intended to illustrate the general characteristics of methods and/or structure utilized in some example embodiments and to supplement the written description provided below. These drawings are not, however, to scale and may not precisely reflect the precise structural or performance characteristics of any given example, and should not be interpreted as defining or limiting the range of values or properties encompassed by some example embodiments.

### DETAILED DESCRIPTION

One or more example embodiments will be described in detail with reference to the accompanying drawings. Some example embodiments, however, may be embodied in various different forms, and should not be construed as being limited to only the illustrated examples. Rather, the illustrated examples are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which some example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously or contemporaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the special purpose program code is loaded into a processor, the processor becomes specially programmed to perform the special purpose program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing some example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of some example embodiments, or they may be known devices that are altered and/or modified for the purposes of some example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of some example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments will be described with reference to the accompanying drawings.

A battle join method according to some example embodiments may be implemented through a computer apparatus, such as an electronic device or a server, which is described below. Here, a computer program according to some example embodiments may be installed and executed on the computer apparatus. The computer apparatus may perform the battle join method according to some example embodiments under control of the executed computer program. The computer program may be stored in a non-transitory computer-readable storage medium to perform the game replay method on the computer apparatus in conjunction with the computer apparatus.

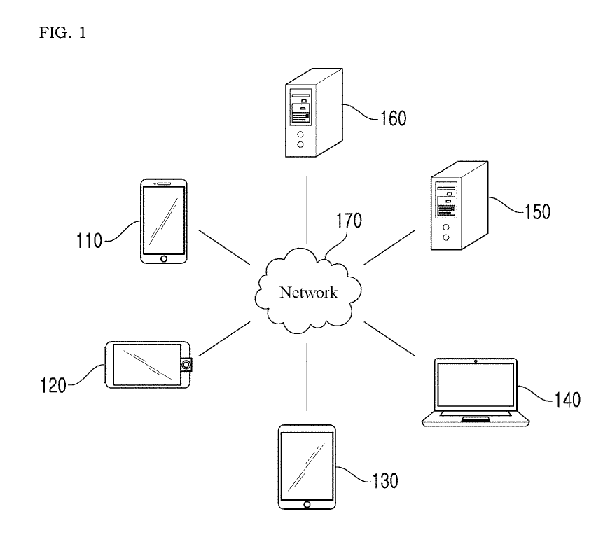

FIG. 1 is a diagram illustrating an example of a network environment according to at least one example embodiment. Referring to FIG. 1, the network environment includes a plurality of electronic devices 110, 120, 130, and 140, etc., a plurality of servers 150 and 160, etc., and a network 170. FIG. 1 is provided as an example only and thus, a number of electronic devices and/or a number of servers are not limited thereto.

Each of the plurality of electronic devices 110, 120, 130, and 140 may be a fixed terminal or a mobile terminal configured as a computer apparatus. For example, the plurality of electronic devices 110, 120, 130, and 140 may be a smartphone, a mobile phone, a personal navigation device, a computer, a laptop computer, a digital broadcasting terminal, a personal digital assistant (PDA), a portable multimedia player (PMP), and/or a tablet personal computer (PC). For example, although FIG. 1 illustrates the shape of a smartphone as an example of the electronic device 110, the electronic device 110 may refer to one of various physical computer apparatuses capable of communicating with other electronic devices 120, 130, and 140, and/or the servers 150 and 160 over the network 170 in a wired communication manner and/or in a wireless communication manner.

The communication scheme is not particularly limited and may include a communication method using a near field communication between devices as well as a communication method using a communication network, for example, a mobile communication network, the wired Internet, the wireless Internet, a broadcasting network, etc., which may be included in the network 170. For example, the network 170 may include at least one of network topologies that include, for example, a personal area network (PAN), a local area network (LAN), a campus area network (CAN), a metropolitan area network (MAN), a wide area network (WAN), a broadband network (BBN), and/or the Internet. Also, the network 170 may include at least one of network topologies that include a bus network, a star network, a ring network, a mesh network, a star-bus network, a tree or hierarchical network, and/or the like. However, these are only examples of possible network configuration(s) and some example embodiments are not limited thereto.

Each of the servers 150 and 160 may be configured as a computer apparatus or a plurality of computer apparatuses that provides computer-readable instructions, codes, files, contents, services, and/or the like through communication with the plurality of electronic devices 110, 120, 130, and/or 140 over the network 170. For example, the server 150 may be a system that provides a service, for example, a game service, a social network service (SNS), a messaging service, a search service, a mail service, and/or a content providing service, etc., to the plurality of electronic devices 110, 120, 130, and/or 140 over the network 170.

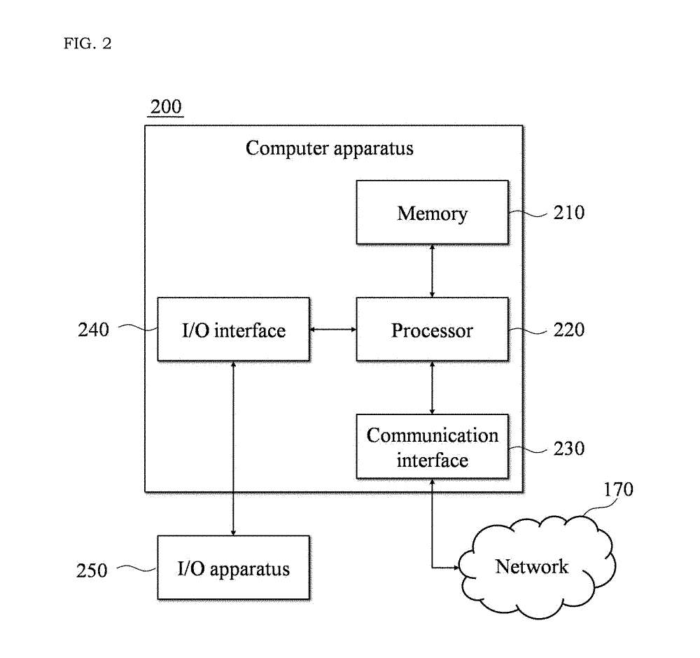

FIG. 2 is a block diagram illustrating an example of a computer apparatus according to at least one example embodiment. Each of the plurality of electronic devices 110, 120, 130, and 140, and/or each of the servers 150 and 160 may be configured through a computer apparatus 200 of FIG. 2.

Referring to FIG. 2, the computer apparatus 200 may include a memory 210, at least one processor 220, a communication interface 230, and/or an input/output (I/O) interface 240. The memory 210 may include a permanent mass storage device, such as random access memory (RAM), read only memory (ROM), a disk drive, a solid state drive (SSD), a flash memory, etc., as a non-transitory computer-readable storage medium. Here, the permanent mass storage device, such as ROM, SSD, flash memory, disk drive, etc., may be included in the computer apparatus 200 as a permanent storage device separate from the memory 210. Also, an OS or at least one program code may be stored in the memory 210. Such software components may be loaded to the memory 210 from another non-transitory computer-readable storage medium separate from the memory 210. The other non-transitory computer-readable storage medium may include a non-transitory computer-readable storage medium, for example, a floppy drive, a disc, a tape, a Blu-ray/DVD/CD-ROM drive, a memory card, etc. According to some example embodiments, software components may be loaded to the memory 210 through the communication interface 230, instead of, or in addition to, the non-transitory computer-readable storage medium. For example, software components may be loaded to the memory 210 of the computer apparatus 200 based on a computer program installed by files provided over the network 170.

The processor 220 may be configured to process computer-readable instructions of a computer program by performing basic arithmetic operations, logic operations, and/or I/O operations. The computer-readable instructions may be provided from the memory 210 and/or the communication interface 230 to the processor 220. For example, the processor 220 may be configured to execute received instructions in response to the program code stored in the storage device, such as the memory 210. Additionally, the processor 220 may be two or more processors arranged in a multi-processor configuration, a distributed processor configuration, a cloud computing configuration, etc. Moreover, each processor of the at least one processor 220 may be a multi-core processor, but some example embodiments are not limited thereto.

The communication interface 230 may provide a function for communication between the computer apparatus 200 and another apparatus, for example, the aforementioned storage device, over the network 170. For example, the processor 220 of the computer apparatus 200 may transfer a request or an instruction, created based on a program code stored in the storage device such as the memory 210, data, a file, etc., to other devices over the network 170 under control of the communication interface 230. Inversely, a signal, an instruction, data, a file, etc., from another apparatus may be received at the computer apparatus 200 by going through the communication interface 230 of the computer apparatus 200 and the network 170. For example, a signal, an instruction, data, etc., received through the communication interface 230 may be transferred to the processor 220 and/or the memory 210, and content, a file, etc., may be stored in a storage medium, for example, the aforementioned permanent storage device, further includable in the computer apparatus 200.

The I/O interface 240 may be a device used for interface with an I/O apparatus 250. For example, an input device may include a device, such as a microphone, a keyboard, a mouse, and/or a camera, etc., and an output device may include a device, such as a display, a speaker, and/or a haptic feedback device, etc. As another example, the I/O interface 240 may be a device for interface with an apparatus in which an input function and an output function are integrated into a single function, such as a touchscreen, etc. The I/O apparatus 250 may be configured as a single apparatus with the computer apparatus 200, but is not limited thereto.

According to some example embodiments, the computer apparatus 200 may include a number of components greater than or less than a number of components shown in FIG. 2. For example, the computer apparatus 200 may include at least a portion of the I/O apparatus 250, or may further include other components, for example, a transceiver, a database (DB), and/or the like.

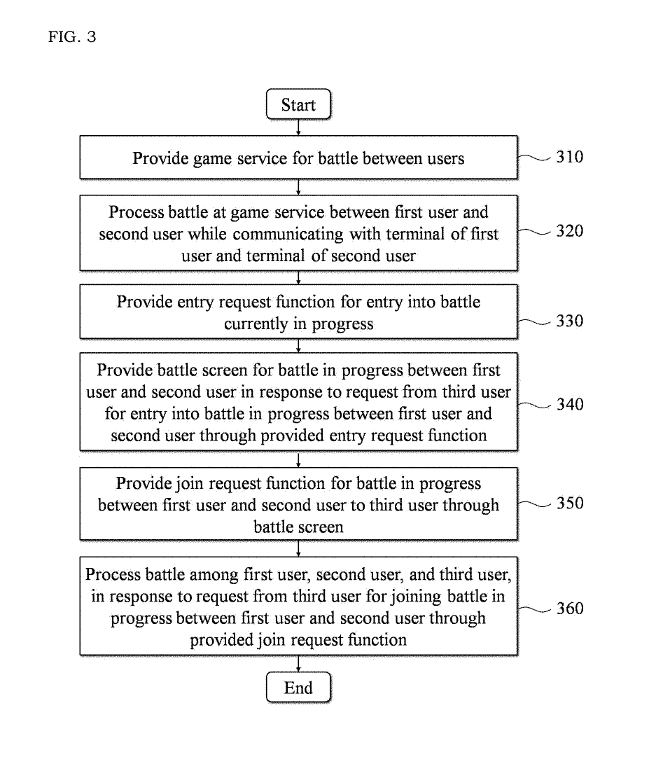

FIG. 3 is a flowchart illustrating an example of a battle join method of a server according to at least one example embodiment. The battle join method according to some example embodiments may be performed by the computer apparatus 200 that implements the server 150 of FIG. 1. For example, the processor 220 of the computer apparatus 200 may be configured to execute a control instruction according to a code of at least one program or a code of an OS included in the memory 210. Here, the processor 220 may control the computer apparatus 200 to perform operations 310 to 360 included in the battle join method of FIG. 3 in response to one or more control instructions provided from a code stored in the computer apparatus 200.

Referring to FIG. 3, in operation 310, the computer apparatus 200 may provide a game service for a battle (e.g., a game battle) between users. According to some example embodiments, the computer apparatus 200 may provide the game service by establishing a communication session between the users (e.g., between a first and second terminal). One of game services for various types of battle games may be provided. The battle join method according to some example embodiments may be applied to the game services. A game service may be provided to the users through communication with terminals of the users over a network. To this end, a computer program, for example, a game app, linked with the game service may be installed and executed on the terminals of the users.

In operation 320, the computer apparatus 200 may process a battle at the game service between a first user and a second user while communicating with a terminal of the first user and a terminal of the second user. One of ordinary skill in the art would understand that the computer apparatus 200 could process the battle provided using the game service by any of several known processes and/or technologies and further disclosure thereof will not be provided herein in detail. The methods of processing the battle may vary per game.

In operation 330, the computer apparatus 200 may provide an entry request function for entry into the battle currently in progress. The entry request function may be provided to the users using a variety of methods. For example, the computer apparatus 200 may provide a notification about the battle currently in progress to the terminals of the users (e.g., the terminal of the first user and the terminal of the second user). The provided notification may include a link to the entry request function, and each of the users may receive the entry request function through the notification and may request entry into the battle currently in progress. According to some example embodiments, the computer apparatus 200 may generate the link (e.g., a uniform resource locator (URL) and/or hyperlink) to be included in the entry request function and/or notification. As another example, the computer apparatus 200 may provide information on battles joined by other users having a personal relationship established with the users (e.g., a friendship link, and/or association, in a social network service and/or game chat). As another example, the computer apparatus 200 may provide the entry request function or the notification through various types of game screens displayed on the terminals of the users. According to some example embodiments, the entry request function is a control instruction which the processor 220 of the computer apparatus 200 is configured to execute to cause a third user to enter the battle in progress. According to some example embodiments, the entry request function is a notification and/or hyperlink configured to cause a third user to enter the battle in progress upon receipt of an input from the third user.

In operation 340, the computer apparatus 200 may provide (e.g., enable display on the terminals of the users of) information for a battle screen (e.g., graphical user interface (GUI)) for the battle in progress between the first user and the second user in response to a request from a third user for entry into the battle in progress between the first user and the second user through the provided entry request function. Here, the third user may observe the battle in progress between the first user and the second user on the battle screen. When a personal relationship is assumed to be established between the third user and the first user, a notification about the battle in progress between the first user and the second user may be provided to the third user. In response to a selection from the third user on the provided notification, for example, in response to a touch of the third user using a finger on an area on which the notification is displayed on a touchscreen in a touch screen environment, an entry request signal for the battle in progress between the first user and the second user may be transmitted to the computer apparatus 200. In this case, in response to the entry request signal, the computer apparatus 200 may generate information that enables the battle screen to be configured and displayed on a screen of a terminal of the third user and may transmit the information to the terminal of the third user. The third user may observe the battle in progress between the first user and the second user on the battle screen that is displayed on the screen of the terminal.

In operation 350, the computer apparatus 200 may provide a join request function for the battle in progress between the first user and the second user to the third user through the battle screen. The join request function may be provided to the third user in a form of a user interface, such as a join button that is displayed with the battle screen. For example, in response to a selection from the third user on the join button that is displayed on the screen, the terminal of the third user may transmit a join request signal to the computer apparatus 200. According to some example embodiments, the join request function is a control instruction which the processor 220 of the computer apparatus 200 is configured to execute to cause a third user to join the battle in progress. According to some example embodiments, the join request function is a notification and/or hyperlink configured to cause a third user to join the battle in progress upon receipt of an input from the third user.

In operation 360, the computer apparatus 200 may process the battle among the first user, the second user, and the third user, in response to the request from the third user for joining the battle in progress between the first user and the second user through the provided join request function. For example, in response to a selection from the third user on the join button, the computer apparatus 200 may receive the join request signal from the terminal of the third user, and in response to the join request signal, allow the third user to join the battle in progress between the first user and the second user and may process the battle among the first user, the second user, and the third user.

Here, the computer apparatus 200 may process a progress of the battle by allowing the third user to join the battle on a side of one of the first user and the second user. As discussed above, an algorithm for processing the progress of the battle may vary per game and a detailed discussion of such algorithms will not be provided herein. However, for example, the computer apparatus 200 may provide a function that enables the third user to deploy and/or control a unit (e.g., a game unit such as one or more characters, weapons, buildings, resources, etc.) allocated to the third user at the game service (e.g., within the game) in the battle in progress between the first user and the second user, and may provide a battle progress process and result to each of the first user, the second user, and the third user based on deployments of each of the first user, the second user, and the third user, and units under control thereof.

The battle game in progress may limit a number of users joining such that the same or similar number (e.g., quantity) of users may play on each side (e.g., team, camp and/or alliance) in the battle game, or a number of users on one side may be greater than a number of users on the other side, such as 1:1, 1:2, 2:2, or 2:3. For example, the computer apparatus 200 may control a number of users that join the battle game such that the difference in the number of users between sides, does not exceed two users, such as 1:3 or 2:4. If a fourth user requests to join the battle in progress among the first user, the second user, and the third user through the entry request function and the join request function, the computer apparatus 200 may process the progress of the battle by allowing the fourth user to join the battle on a side different from the side of the third user. For example, if the third user and the first user take the same or similar side, the fourth user may be set to take the same or similar side with the second user.

As described above, joining a battle may be based on a personal relationship between users. The personal relationship between the users can be set, for example, by inviting a friend as in a general game. As another example, the personal relationship may be automatically set using a relationship graph in the social network service associated with the game service. Here, the third user may have a personal relationship established with the first user or the second user. For example, in operation 330, the computer apparatus 200 may provide a notification including the entry request function for the battle in progress between the first user and the second user to other users having a personal relationship established with the first user and/or other users having a personal relationship established with the second user based on a personal relationship (e.g., personal relationship data) managed for the users. When a personal relationship is established between the third user and the first user, the notification may be provided to the third user and the third user may request the computer apparatus 200 to enter and/or join the corresponding battle through the link included in the notification. In this case, when the third user enters and joins the battle, the third user may be set to be on the side of the first user. If a fifth user having a personal relationship established with the first user desires to join the corresponding battle, the fifth user may not be permitted to join the battle because the addition of the fifth user would result in a difference between the number of users on each side of two or more. Here, if the fourth user having a personal relationship established with the second user desires to join the corresponding battle, the fourth user may join the battle on the side of the second user.

As another example for joining a battle, the third user may request entry into any battle. For example, in response to a request from the third user for entry into any battle using a link set as the entry request function through a game service screen of each of the users, the computer apparatus 200 may verify (e.g., determine) a grade of the third user, may search for (e.g., determine) battles between other users currently in progress within the verified grade (e.g., within a defined threshold range and/or threshold of the grade of the third user), and may select a single battle the third user is allowed to join. A grade of a user may correspond to the stage, and the stage available to the user may be limited depending on the grade of the user. For example, if the grade of the user is 3, then the user may use the stages corresponding to grade 1, grade 2, and grade 3. In one embodiment, the game service may provide a plurality of stages that users must subvert sequentially. Each stage may have a landmark symbolizing the stage. The neighboring stages among the plurality of stages may have relative directionality with respect to each other. For example, in the game map, the second grade stage may be arranged in the upward direction of the first grade stage and the downward direction of the third grade stage. The battle may be selected based on a variety of information, for example, an amount of resources allocated to each of the users, winning streak of each of the users, and/or the like, in addition to a grade-based matching. For example, the computer apparatus 200 may select a battle in which a number of participants joining a battle currently in progress is imbalanced such as 2:1 or 3:2 and may offer the selected battle to the third user that requests to join any battle. Here, if the third user selects the offered battle, the computer apparatus 200 may allow the third user to take a camp, that is, a side, on which a number of participants is relatively small (e.g., the side having fewer users) and to join the selected battle. As another example, the computer apparatus 200 may select a battle in which a battle situation of one side is worse (e.g., one side of the battle is losing, and/or in a more disadvantageous position) by a determined (or, alternatively, desired) level or more from among battles currently in progress and may offer the selected battle to the third user as an available battle. Here, if the third user selects the offered battle, the computer apparatus 200 may allow the third user to join the battle on the camp of which the battle situation is worse. As another example, the computer apparatus 200 may select a battle including a participant winning victories in a row by a determined (or, alternatively, desired) number or more from among participants of battles currently in progress and may offer the selected battle to the third user as an available battle. Here, if the third user selects the offered battle, the computer apparatus 200 may allow the third user to join the selected battle on an opposing camp, that is, side, of the participant that is winning victories in a row by the number or more. As another example, the computer apparatus 200 may calculate a game ability (e.g., user skill at playing the game) used to numerically evaluate levels of both camps, for example, the average level or the average grade of participants of the both camps with respect to each of the battles currently in progress, may select a battle in which the calculated game ability between both camps shows a determined (or, alternatively, desired) level of difference or more, and may offer the selected battle to the third user. Here, if the third user selects the offered battle, the computer apparatus 200 may allow the third user to join the battle on a camp having a relatively low game ability. When a plurality of battles is selected in each of the above examples, the computer apparatus 200 may provide a list of the plurality of battles to the third user such that the third user may select a desired battle from the list. Also, each of the examples, the computer apparatus 200 may select a battle based on a complex selection condition through a numerical expression according to a battle section condition. For example, the computer apparatus 200 may calculate scores according to each of at least two of the aforementioned conditions, for example, a grade of a user, imbalance in a number of participants between camps, an unfavored battle situation, winning streak of a participant, and/or a difference in game ability between camps, of the above examples, and may select a battle corresponding to the highest score through a weighted sum of the calculated scores as a battle for the third user.

Also, the battle for the third user may be selected based on an amount of time over which each battle has progressed. For example, only a battle being played a first time period (e.g., 15 seconds) or more after the start of the battle be selected as a target of selection, or only a battle being played within a second time (e.g., 10 minutes) or less after the start of the battle may be selected as the target of selection.

Also, the computer apparatus 200 may request corresponding users to pay a fee to enter and/or join a battle. For example, in operation 340, the computer apparatus 200 may collect an entrance fee from the third user by subtracting the fee according to the third user's entry into the selected battle from an amount of resources allocated to the third user at the game service (e.g., an account of the user maintained and/or accessed by the game service). As another example, in operation 360, the computer apparatus 200 may subtract the fee according to the third user's joining the corresponding battle from an amount of resources allocated to the third user at the game service.

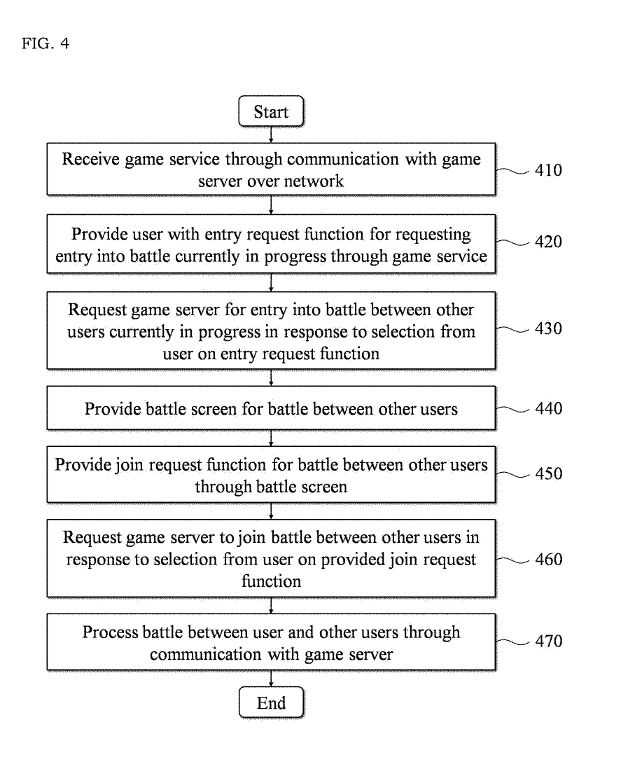

FIG. 4 is a flowchart illustrating an example of a battle join method of a client according to at least one example embodiment. The battle join method according to the at least one example embodiment may be performed by the computer apparatus 200 that implements one of the plurality of electronic devices 110, 120, 130, and/or 140 of FIG. 1. For example, the processor 220 of the computer apparatus 200 may be configured to execute a control instruction according to a code of at least one program or a code of an OS included in the memory 210. Here, the processor 220 may control the computer apparatus 200 to perform operations 410 to 470 included in the battle join method of FIG. 4 in response to a control instruction provided from a code stored in the computer apparatus 200.

Referring to FIG. 4, in operation 410, the computer apparatus 200 may receive a game service through communication with a game server over a network. As described above, one or more of a plurality of game services providing various types of battle games may be provided. A client program, for example, a game app, may be installed and executed on the computer apparatus 200 and may control the computer apparatus 200 to receive the game service provided from the game server over the network.

In operation 420, the computer apparatus 200 may provide a user with an entry request function for requesting an entry into a battle currently in progress through the game service. As described above, the entry request function may be provided to users using a variety of methods. For example, the computer apparatus 200 according to the at least one example embodiment may display a notification provided from the game server on a screen (e.g., a GUI). The notification may include a link for transmitting an entry request signal to the game server as the entry request function (e.g., in response to an input from a user of the computer apparatus 200). As another example, the computer apparatus 200 may display a list of other users having a personal relationship established with the user on the screen under control of the client program. Here, information regarding whether each of the other users is currently proceeding with a battle may be provided using the list. In detail, the information may include status information regarding whether the users included in the list are connecting or playing, or whether the users are watching another battle. In the latter case, the corresponding information (e.g., status information) may include a link for transmitting an entry request signal for a corresponding battle currently in progress to the game server and the user may request an entry into the battle the other user is proceeding with through the corresponding link. As another example, the computer apparatus 200 may provide the entry request function or the notification through various types of game screens displayed on a display of the computer apparatus 200.

In operation 430, the computer apparatus 200 may request the game server for entry into a battle between other users currently in progress in response to a selection from the user on the entry request function. As described above, the computer apparatus 200 may request the game server for entry into the battle by transmitting an entry request signal generated in response to the selection from the user to the game server. In detail, the entry request signal may include information used by the game server to verify which user desires to join which battle, such as an identifier of the user and/or an identifier of the battle.

In operation 440, the computer apparatus 200 may provide a battle screen for the battle between the other users. For example, the battle screen provided in operation 340 of FIG. 3 may be provided from the game server and displayed on the display of the computer apparatus 200. Here, the game server may provide information used for the computer apparatus 200 to configure the battle screen, and the computer apparatus 200 may directly generate the battle screen for the battle between other users based on provided information under control of the client program and may display the battle screen on the display (e.g., GUI).

In operation 450, the computer apparatus 200 may provide a join request function for the battle between the other users through the battle screen. For example, the computer apparatus 200 may further include a user interface element, such as a join request button, to generate the battle screen under control of the client program and may display the user interface element on the battle screen.

In operation 460, the computer apparatus 200 may request the game server to join the battle between the other users in response to a selection from the user on the provided join request function. For example, in response to a selection, for example, click or touch, from the user on the join request button, the computer apparatus 200 may generate a join request signal and may transmit the generated join request signal to the game server. Here, the join request signal may include information used by the game server to verify which user desires to join which battle, such as an identifier of the user and/or an identifier of the battle.

In operation 470, the computer apparatus 200 may process the battle between the user and the other users through communication with the game server. For example, the computer apparatus 200 may transmit information associated with a unit selection, deployment, and/or control of (e.g., by) the user to the game server under control of the client program. The game server may collect information associated with a unit (e.g., a game unit such as one or more characters, weapons, buildings, resources, etc.) selection, deployment, and/or control with respect to the entire users (e.g., all users) joining the battle and thereby run the battle, and may provide information associated with a battle progress process and/or result to each of the users joining the battle. Here, the computer apparatus 200 may generate and display the battle screen regarding the battle progress process and result, based on information provided from the game server.

According to at least one example embodiment, in operation 410, the computer apparatus 200 may display a portion on which a first stage corresponding to a first grade of the user is displayed in a game field on which a plurality of grades is displayed as a plurality of stages on a screen of the user. Here, the computer apparatus 200 may display a notification about a battle between other users of the first grade on the screen of the user in association with the first stage.

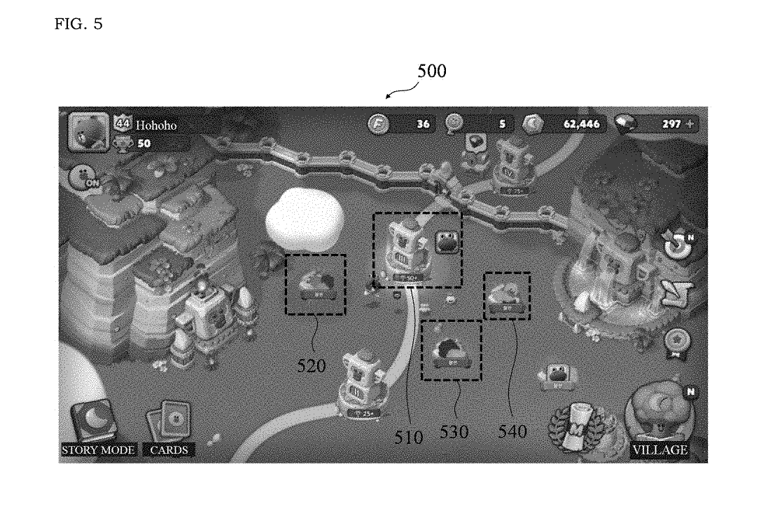

FIG. 5 illustrates a first example of a game implementation that provides a notification about a battle according to at least one example embodiment. FIG. 5 illustrates an example of a game screen 500. Referring to FIG. 5, a first box 510 indicated with dotted lines represents a landmark of a stage (e.g., game level) set based on a grade of a user. Here, “JOIN BATTLE” icons for battles currently in progress between users of the corresponding grade, such as a second box 520, a third box 530, and a fourth box 540, each indicated with dotted lines, are displayed on the game screen 500. For example, in response to a selection from the user on the “JOIN BATTLE” icon represented by the second box 520, a terminal of the user may transmit an entry request signal into a battle corresponding to the “JOIN BATTLE” icon of the second box 520 to a game server. That is, the “JOIN BATTLE” icons of FIG. 5 may be (e.g., correspond to) entry request functions into corresponding battles while also providing notifications for the battles currently in progress between other users having the same or similar grade as the grade of the user. Here, a number of notifications displayed on the game screen 500 may be limited. For example, if the number of battles currently in progress is greater than or equal to a determined (or, alternatively, desired) number, only notifications for a number of selected battles may be displayed on the game screen 500. Display priority of a notification may be determined based on a personal relationship of a corresponding user. For example, a notification about a battle joined by another user having a personal relationship established with the user has a higher priority compared to a notification about a battle between other users not having a personal relationship established with the user. Also, display priority for battles joined by other users having a personal relationship established with the user may be determined based on intimacy between the users. For example, the intimacy between a first user and a second user may be calculated using at least one of various factors such as the number of messages delivered between the first user and the second user, the number of the first user participating in competitions of the second user, and/or the number of the second user participating in competitions of the first user. For example, the greater the number of messages, and/or the greater the number of participating, the greater the intimacy between the first user and the second user can be set.

According to at least one example embodiment, in operation 420 of FIG. 4, the computer apparatus 200 may determine a display location of a notification about a battle between other users of a grade different from the first grade based on a direction of a stage corresponding to the different grade based on the first stage. Here, the computer apparatus 200 may display a corresponding notification at the determined display location.

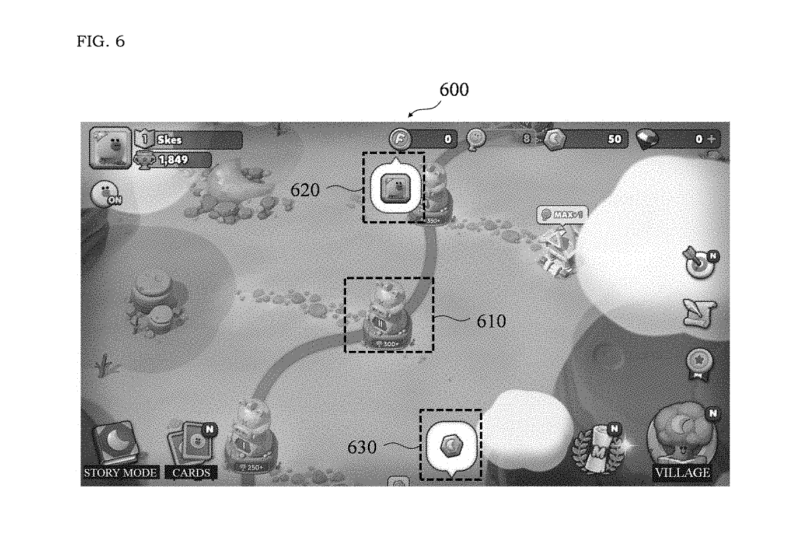

FIG. 6 illustrates a second example of a game implementation that provides a notification about a battle according to at least one example embodiment. FIG. 6 illustrates an example of a game screen 600. Referring to FIG. 6, a first box 610 indicated with dotted lines represents a landmark of a stage set based on a grade of a user, which is described above. Also, each of a second box 620 indicated with dotted lines and a third box 630 indicated with dotted lines represents a notification about a battle currently in progress. Here, the notification represented by the second box 620 corresponds to an example in which a display location of the notification is determined based on a direction of a stage corresponding to a grade higher than the grade of the user (e.g., the second box 620 is depicted at the top of the game screen 600 corresponding to a stage of a higher grade), and the notification represented by the third box 630 corresponds to an example in which a display location of the notification is determined based on a direction of a stage corresponding to a grade lower than the grade of the user (e.g., the third box 630 is depicted at the bottom of the game screen 600 corresponding to a stage of a lower grade). That is, the user may verify that a battle corresponding to a notification is a battle between users of a grade higher than or lower than the grade of the user only with the display location of the notification. In response to a selection from the user on the notification, an entry request signal into a battle corresponding to the selected notification may be transmitted from the terminal of the user to the game server. Also, the display location of the notification may be changed in response to a movement of a display location of a field on the game screen 600.

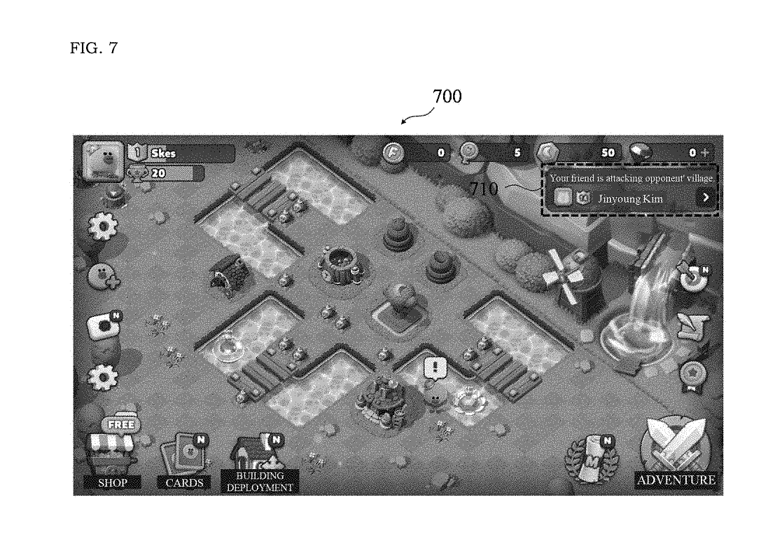

FIG. 7 illustrates a third example of a game implementation that provides a notification about a battle according to at least one example embodiment. FIG. 7 illustrates an example of a game screen 700. Referring to FIG. 7, a first box 710 indicated with dotted lines represents an example of displaying a notification about a battle currently in progress on a main screen of a game in a popup form. Even in this case, in response to a selection from a user on the notification, an entry request signal for the battle corresponding to the selected notification may be transmitted from a terminal of the user to the game server.

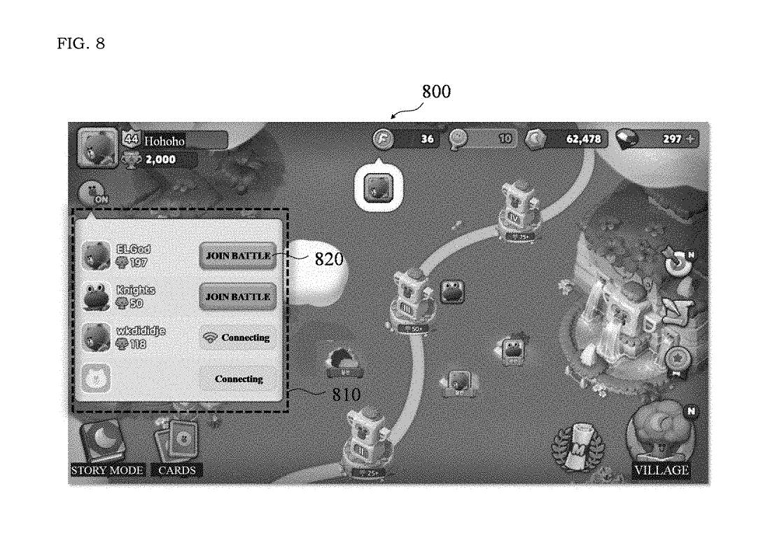

FIG. 8 illustrates a fourth example of a game implementation that provides a notification about a battle according to at least one example embodiment. FIG. 8 illustrates an example of a game screen 800. Referring to FIG. 8, a first box 810 indicated with dotted lines represents a list of other users having a personal relationship established with a user. Here, a “JOIN BATTLE” button 820 may be a notification indicating that a corresponding user ‘ELGod’ is currently proceeding with a battle and an entry request function for the battle joined by the user ‘ELGod’. The notification may be used to provide information on a current status, for example, currently joining the battle, observing the battle, and/or connecting, of corresponding another user. The notification may provide an entry request function that allows the user to enter the battle the other user is joining or observing.

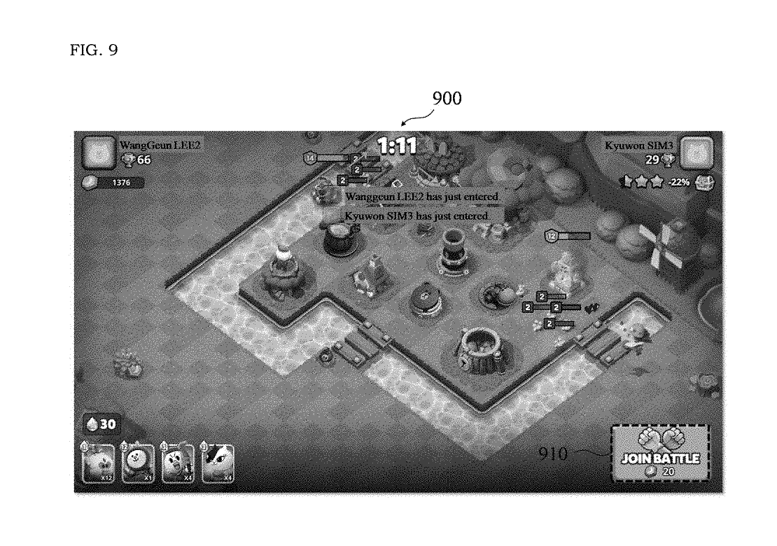

FIG. 9 illustrates an example of a battle observation screen according to at least one example embodiment. FIG. 9 illustrates an example of a game screen 900 on which a user may enter a battle between other users and observe a progress status of the battle. A status, for example, a unit deployment and/or movement, of a battle between other users may be displayed on the game screen 900. Here, a join request function for the corresponding battle may be transmitted to the user, such as, a “JOIN BATTLE” button represented by a first box 910 indicated with dotted lines on the game screen 900. For example, in response to the user pressing the “JOIN BATTLE” button, a join request signal for the battle may be transmitted from a terminal of the user to the game server. Here, number ‘20’ included in the “JOIN BATTLE” button may indicate a cost (e.g., an amount of resources) for the user to join the corresponding battle. That is, in response to the user pressing the “JOIN BATTLE” button, an amount of resources corresponding to ‘20’ may be reduced from an amount of resources allocated to the user.

In some example embodiments, a first user currently joining a battle may request help from a second user having a personal relationship established with the first user. Here, a notification about the request for help may be displayed on a game screen of the second user.

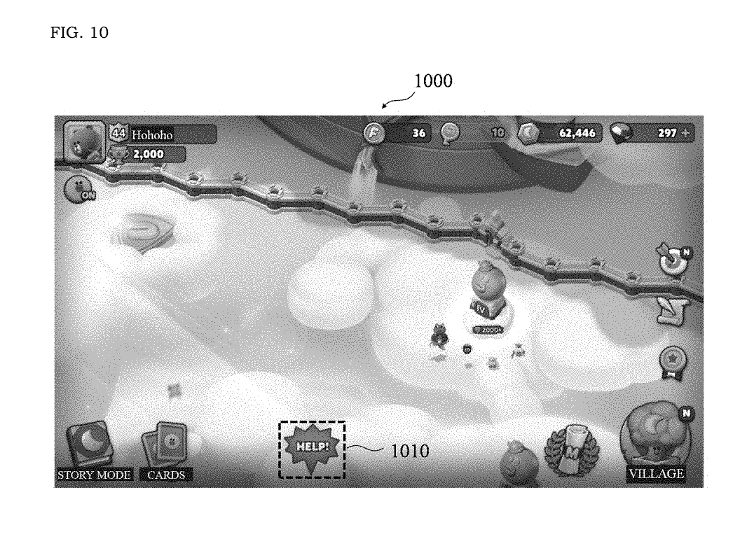

FIG. 10 illustrates an example of a game implementation that provides a notification about a request for help according to at least one example embodiment. FIG. 10 illustrates an example of a game screen 1000. Referring to FIG. 10, a first box 1010 indicated with dotted lines represents an example of displaying a notification about a request for help from another user. In response to a selection from a user on the notification, an entry request signal into a battle joined by the other user may be transmitted from a terminal of the user to the game server. Here, a display location of the notification about the request for help may be determined based on a grade of the user and a stage, as described above.

Conventional game servers, terminals and/or methods provide a game battle to first and second users for which the game battle is generated. The conventional game servers, terminals and/or methods do not provide the functionality for a third user to observe and/or join and existing game battle between the first and second users after the game battle has been generated and the battle has commenced. However, some example embodiments provide improved servers, terminals and/or methods that provide a third terminal with an entry request function and/or a join request function. Accordingly, the improved servers, terminals and/or methods provide the functionality for a third user to observe and/or join and existing game battle between the first and second users after the game battle has been generated and the battle has commenced. Therefore, the improved servers, terminals and/or methods provide functionality lacking in the conventional servers, terminals and/or methods. According to some example embodiments, it is possible to provide a new fun and strategy for a battle game by providing a game service such that a user may enter a battle currently in progress between other users, may observe a progress of the battle, and may directly join the battle if desired.

The systems and/or apparatuses described herein may be implemented using hardware components, software components, and/or a combination thereof. For example, a processing device may be implemented using for example, a processor, a controller and an arithmetic logic unit, a digital signal processor, a microcomputer, a field programmable array, a programmable logic unit, a microprocessor and/or any other device capable of responding to and/or executing instructions in a defined manner. The processing device may run an operating system (OS) and/or one or more software applications that run on the OS. The processing device also may access, store, manipulate, process, and/or create data in response to execution of the software. For purpose of simplicity, the description of a processing device is used as singular; however, one skilled in the art will appreciated that a processing device may include multiple processing elements and multiple types of processing elements. For example, a processing device may include multiple processors and/or a processor and a controller. In addition, different processing configurations are possible, such as parallel processors.

The software may include a computer program, a piece of code, an instruction, and/or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to some example embodiments may be recorded in non-transitory computer-readable media including program instructions to implement various operations embodied by a computer. The media may also include, alone or in combination with the program instructions, data files, data structures, and/or the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described examples, or vice versa.

The foregoing description has been provided for purposes of illustration and description. It is not intended to be exhaustive or to limit the disclosure. Individual elements or features of some example embodiments are generally not limited to at least one particular example embodiment, but, where applicable, are interchangeable and can be used in some example embodiments, even if not specifically shown or described. The same may also be varied in many ways. Such variations are not to be regarded as a departure from the disclosure, and all such modifications are intended to be included within the scope of the disclosure.

What is claimed is:

1. A method performed by a server, the method comprising:
establishing a communication session between a first terminal and a second terminal, the communication session involving a game battle between a first user of the first terminal and a second user of the second terminal;
providing a first entry request function to a third terminal, the first entry request function being configured to enable a third user of the third terminal to observe the game battle while the game battle is in progress;
providing information for a battle screen corresponding to the game battle in progress in response to a request received through the provided first entry request function;
providing a first join request function to the third terminal through the battle screen, the first join request function being configured to enable the third user to join the game battle in progress; and
processing the game battle among the first user, the second user, and the third user, in response to a request received through the provided first join request function.

2. The method of claim 1, wherein the processing the game battle includes allowing the third user to join the game battle on a first side corresponding to one of the first user or the second user.

3. The method of claim 2, wherein the processing the game battle includes allowing a fourth user to join the game battle on a second side different from the first side in response to receiving a request through a second entry request function and a request through a second join request function.

4. The method of claim 1, wherein the providing the first entry request function includes providing a notification including the first entry request function for the game battle in progress to one or more other users having a personal relationship with at least one of the first user or the second user based on personal relationship data managed for the one or more other users.

5. The method of claim 4, wherein the third user has a personal relationship with at least one of the first user or the second user.

6. The method of claim 1, wherein the providing the first entry request function includes
determining a grade of the third user,
determining one or more game battles in progress between one or more other users within a defined threshold amount of the grade of the third user, and
generating a link to be included in the first entry request function, the link corresponding to a selected single battle the third user is allowed to join.

7. The method of claim 6, wherein the providing the information for the battle screen includes subtracting a fee corresponding to entry of the third user into the selected single battle from resources allocated to the third user at a game service.

8. A method performed by a terminal, the method comprising:
causing display of a graphical user interface associated with a game service provided by a game server, the graphical user interface providing an entry request function configured to enable a user of the terminal to observe a game battle among two or more other users while the game battle is in progress through the game service;
providing a request to the game server to observe the game battle in progress in response to a selection from the user associated with the entry request function;
causing display of the graphical user interface including a battle screen for the game battle, the graphical user interface providing a join request function configured to enable the user to join the game battle in progress;
providing a request to the game server to join the game battle in progress in response to a selection from the user associated with the join request function; and
processing the game battle between the user and the two or more other users through communication with the game server.

9. The method of claim 8, wherein the graphical user interface provides the entry request function to the user through a notification about the game battle in which at least one other user among the two or more other users has a personal relationship with the user.

10. The method of claim 8, wherein
the graphical user interface includes a game field on which a plurality of grades is displayed as a plurality of stages, the game field including a portion on a first stage corresponding to a first grade of the user, and
the graphical user interface includes a notification associated with the game battle among the two or more other users in association with the first stage, the two or more other users corresponding to the first grade, the notification corresponding to the entry request function.

11. The method of claim 10, further comprising:
determining a display location on the graphical user interface for a notification associated with the game battle among the two or more other users, the two or more other users corresponding to a grade different from the first grade, the display location being based on the first stage and a difference between the grade corresponding to the two or more other users and the first grade, the notification corresponding to the entry request function.

12. The method of claim 8, wherein
the graphical user interface includes information associated with a plurality of game battles of a plurality of other users included in a list of users, the plurality of game battles including the game battle in progress, each of the plurality of other users having a personal relationship with the user, and
the information associated with the plurality of game battles including a link corresponding to the entry request function.

13. A non-transitory computer-readable storage medium storing instructions that, when executed by at least one processor, cause the at least one processor to perform the method of claim 1.

14. A computer apparatus comprising:
at least one processor configured to execute computer-readable instructions to
establish a communication session between a first terminal and a second terminal, the communication session involving a game battle between a first user of the first terminal and a second user of the second terminal,
provide an entry request function to a third terminal, the entry request function being configured to enable a third user of the third terminal to observe the game battle while the game battle is in progress,
provide information for a battle screen corresponding to the game battle in progress in response to a request received through the provided entry request function,
provide a join request function to the third terminal through the battle screen, the join request function being configured to enable the third user to join the game battle in progress, and
process the game battle among the first user, the second user, and the third user, in response to a request received through the provided join request function.

15. The computer apparatus of claim 14, wherein the at least one processor is further configured to execute computer-readable instructions to allow the third user to join the game battle on a side corresponding to one of the first user or the second user.

16. The computer apparatus of claim 14, wherein the at least one processor is further configured to execute computer-readable instructions to provide a notification including the entry request function for the game battle in progress to one or more other users having a personal relationship with at least one of the first user or the second user based on personal relationship data managed for the one or more other users.

17. The computer apparatus of claim 14, wherein the at least one processor is further configured to execute computer-readable instructions to
determine a grade of the third user,
determine one or more game battles in progress between one or more other users within a defined threshold amount of the grade of the third user, and
generate a link to be included in the entry request function, the link corresponding to a selected single battle the third user is allowed to join.
